(19) United States
(12) Patent Application Publication
(10) Pub. No.: US 2025/0384678 A1
(43) Pub. Date: Dec. 18, 2025

(54) TARGET DETECTION METHOD AND APPARATUS

(71) Applicant: MASHANG CONSUMER FINANCE CO., LTD., Chongqing (CN)

(72) Inventor: Yejiang ZHOU, Chongqing (CN)

(21) Appl. No.: 18/990,648

(22) Filed: Dec. 20, 2024

(30) Foreign Application Priority Data
Jun. 13, 2024 (CN) 202410777329.2

(51) Int. Cl. G06V 10/82; G06F 40/247; G06F 40/284; G06V 10/25; G06V 10/26; G06V 10/74; G06V 10/764; G06V 10/77; G06V 20/70

(52) U.S. Cl. CPC G06V 10/82; G06F 40/247; G06F 40/284; G06V 10/25; G06V 10/26; G06V 10/761; G06V 10/764; G06V 10/7715; G06V 20/70; G06V 2201/07

(57) ABSTRACT

This disclosure provides a target detection method. In the method, a closed-set detection is performed on an image via a closed-set detection model to obtain a first detection result. An open-set detection is performed on the image via an open-set detection model to obtain a second detection result. Accuracy of the first detection result is higher than accuracy of the second detection result. The first detection result and the second detection result are merged to obtain a target detection result of the image.

### RELATED APPLICATION

The present application claims priority to Chinese Patent Application No. 202410777329.2 filed on Jun. 13, 2024. The entire disclosure of the prior application is hereby incorporated by reference.

### FIELD OF THE TECHNOLOGY

This disclosure relates to the field of artificial intelligence (AI) technologies, including to a target detection method and apparatus, an electronic device, a computer-readable storage medium, and a computer program product.

### BACKGROUND OF THE DISCLOSURE

AI is a comprehensive technology in computer science. Through the research of design principles and implementation methods of various smart machines, a machine is provided with functions of perception, inference, and decision-making. AI technology is a comprehensive discipline and covers a wide range of fields, for example, natural language processing technology, machine learning/deep learning, among other major directions. With the development of technologies, the AI technology will be applied in more fields and play an increasingly important role.

In an example of performing target recognition on an image, to enable a target detection model to recognize all objects in the image as much as possible, the target detection model usually needs to be trained by using a large amount of training data, so that the target detection model “recognizes” images of more classes as much as possible. Although images of more classes can be recognized in this manner, it can be difficult to ensure that all target objects in the image can be recognized, and a large number of training samples need to be used for training.

### SUMMARY

This disclosure provides a target detection method and apparatus, an electronic device, a non-transitory computer-readable storage medium, and a computer program product, so that accuracy of target detection can be improved while open-set detection can be better ensured. Technical solutions in embodiments of this disclosure can be implemented as follows.

An aspect of this disclosure provide a target detection method. In the method, a closed-set detection is performed on an image via a closed-set detection model to obtain a first detection result. An open-set detection is performed on the image via an open-set detection model to obtain a second detection result. Accuracy of the first detection result is higher than accuracy of the second detection result. The first detection result and the second detection result are merged to obtain a target detection result of the image.

An aspect of this disclosure provide a target detection apparatus including processing circuitry. The processing circuitry is configured to perform a closed-set detection on an image via a closed-set detection model to obtain a first detection result. The processing circuitry is configured to perform an open-set detection on the image via an open-set detection model to obtain a second detection result. Accuracy of the first detection result is higher than accuracy of the second detection result. The processing circuitry is configured to merge the first detection result and the second detection result to obtain a target detection result of the image.

An aspect of this disclosure provides an electronic device. The electronic device includes a memory and a processor. The memory is configured to store computer-executable instructions. The processor is configured to execute the computer-executable instructions stored in the memory to implement any of the target detection methods provided in the embodiments of this disclosure.

An aspect of this disclosure provide a non-transitory computer-readable storage medium, storing computer-executable instructions which, when executed by a processor, cause the processor to perform any of the target detection methods provided in the embodiments of this disclosure.

An aspect of this disclosure provide a computer program product, including computer-executable instructions, the computer-executable instructions, when executed by a processor, implementing any of the target detection methods provided in the embodiments of this disclosure.

This disclosure can have the following beneficial effects: Closed-set target detection is performed on a target image by using a closed-set target detection model to obtain a first target detection result. Subsequently, open-set target detection is performed on the target image by using an open-set target detection model to obtain a second target detection result. Detection accuracy of the first target detection result is higher than detection accuracy of the second target detection result. A class of the target image can be accurately recognized by using a closed-set detection model, thereby improving accuracy of a finally obtained target detection result. In addition, classes of all target objects in the target image can be recognized by using an open-set detection model, thereby ensuring that the finally obtained target detection result can include all the target objects in the target image as much as possible. The first target detection result and the second target detection result are fused to obtain a target detection result of the target image. The first target detection result with higher accuracy and the second target detection result that include as many target objects in the target image as possible are fused, so that while the obtained target detection result implements open-set detection, accuracy of target detection is improved.

### BRIEF DESCRIPTION OF THE DRAWINGS

FIG. 1 is a schematic architectural diagram of a target detection system 100 according to an aspect of this disclosure.

FIG. 2 is a schematic structural diagram of an electronic device 500 according to an aspect of this disclosure.

FIG. 3A is a first schematic flowchart of a target detection method according to an aspect of this disclosure.

FIG. 3B is a second schematic flowchart of a target detection method according to an aspect of this disclosure.

FIG. 3C is a third schematic flowchart of a target detection method according to an aspect of this disclosure.

FIG. 3D is a fourth schematic flowchart of a target detection method according to an aspect of this disclosure.

FIG. 4 is a working principle diagram of a segmentation model according to an aspect of this disclosure.

FIG. 5 is an implementation flowchart in an example scenario according to an aspect of this disclosure.

The foregoing “first” and “second” are merely used to distinguish between different solutions, and do not represent quality of the solutions or priorities of the solutions in an implementation process.

### DETAILED DESCRIPTION

To make the objectives, technical solutions, and advantages of this disclosure clearer, the following further describes this disclosure with reference to the accompanying drawings. The described embodiments are not to be considered as a limitation to this disclosure. Other embodiments shall fall within the scope of this disclosure.

In the following descriptions, related “some embodiments” describe a subset of possible embodiments. However, the “some embodiments” may be the same subset or different subsets of all the possible embodiments, and may be combined with each other without conflict.

In the following descriptions, the related term “first/second/third” is merely intended to distinguish between similar objects rather than represent a particular sequence of the objects. A particular sequence or a chronological order indicated by “first/second/third” may be changed, so that the embodiments of this disclosure described herein can be implemented in a sequence other than the sequence illustrated or described herein. The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

In the embodiments of this disclosure, the term “module” or “unit” refers to a computer program or a part of a computer program having a predetermined function, works together with other related parts to achieve a predetermined objective, and may be implemented by using software, hardware (for example, a processing circuit or a memory), or a combination thereof. Similarly, one processor (or a plurality of processors or memories) may be configured to implement one or more modules or units. In addition, each module or unit may be a part of an overall module or unit including a function of the module or unit.

Unless otherwise defined, meanings of all technical and scientific terms used in the embodiments of this disclosure are the same as those usually understood by a person skilled in the art. Terms used in the embodiments of this disclosure are merely intended to describe the specific embodiments of this disclosure, and are not intended to limit this disclosure.

A description is made on terms involved in the embodiments of this disclosure, examples of nouns and terms used in the examples of this disclosure are provided. The descriptions of the terms are provided as examples only and are not intended to limit the scope of the disclosure.
(1) Open-set detection: The open-set detection is a process of detecting a target object by using a machine learning algorithm and a computer vision technology. In this process, the open-set detection mainly recognizes a region or a position of the target object by analyzing an environment around the target object and using an open set theory. Specifically, in an open-set detection technology, a difference between the target object and a surrounding background may be recognized by analyzing pixels or features in an image, to determine a position and a boundary box of a target.
(2) Open-set detection model: The open-set detection model can recognize an unknown target appearing in an image, and is not limited to recognizing predefined classes. For example, models such as a label prompt target detection large model, a deep learning-based prototypical network, an autoencoder, and a multi-task learning model can implement open-set detection.
(3) Closed-set detection: The closed-set detection is a process of detecting and recognizing a target in a predefined class set. The closed-set detection performs target detection in a range of known classes, i.e., a model can only recognize trained classes but cannot recognize a target that appears in an image but does not belong to the known classes.
(4) Closed-set detection model: The closed-set detection model is a target detection model configured to recognize a group of predefined classes. The closed-set detection model focuses on only these classes during training, expects to be able to recognize and locate targets of these classes during testing, and is, for example, a region with CNN features (R-CNN), a mask region with CNN features (mask R-CNN), and a retina network (RetinaNet).

Target detection is a cornerstone in the field of computer vision, and has many applications such as self-driving, machine vision, security videos, and pedestrian detection. In closed-set detection, a Mask-RCNN and a DETR have achieved good effects, but capabilities of these algorithms are limited to classes predefined during training. In the real world, classes of various objects follow a long-tail distribution, there are many rare and uncommon classes, and a closed-set target detector is far from meeting different application scenarios.

Open-set detection is a challenging problem in the field of image detection. Conventional target detection algorithms are essentially closed-set detection, and it is difficult to deal with the problem of detecting new objects. In the early days of target detection, generalized novel class discovery (GNCD) can implement recognition of new objects by using semi-supervision and contrastive learning. However, this manner cannot locate a target object, and therefore has a certain difference from open-set detection.

With vision-language models (NLMs) such as contrastive language-image pretraining (CLIP), open-set detection for target recognition is implemented by using a class name representation capability of a large model through a method of integrating the large model. However, such methods depend on a large amount of training data and computing resources, and costs are extremely high.

Embodiments of this disclosure provide a target detection method and apparatus, an electronic device, a computer-readable storage medium, and a computer program product, so that accuracy of target detection can be improved while open-set detection can be better ensured.

An example of an electronic device in the embodiments of this disclosure is described below. The electronic device provided in the embodiments of this disclosure may be implemented as a laptop computer, a tablet computer, a desktop computer, a set top box, a mobile device, a smart device, an in-vehicle terminal, among various other types of terminals, or may be implemented as a server. An example of the device being implemented as a server is described below.

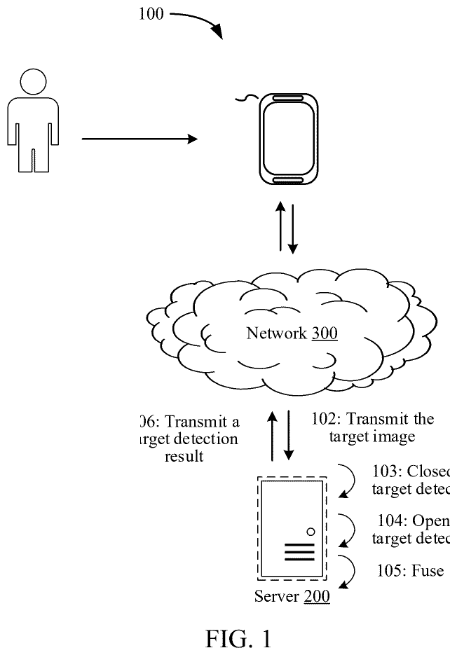

FIG. 1 is a schematic architectural diagram of a target detection system 100 according to an embodiment of this disclosure. To support a target detection application, a terminal 400 is connected to a server 200 by a network 300. The network 300 may be a wide area network, a local area network, or a combination of the two.

The terminal 400 is configured to: obtain a target image for target detection, and then transmit the target image to the server 200 through the network 300.

The server 200 is configured to: receive, through the network 300, the target image transmitted by the terminal 400, then perform closed-set target detection on the target image by using a closed-set target detection model to obtain a first target detection result, perform open-set target detection on the target image by using an open-set target detection model to obtain a second target detection result, detection accuracy of the closed-set target detection model being higher than detection accuracy of the open-set target detection model, and finally fuse (e.g., merge) the first target detection result and the second target detection result to obtain a target detection result of the target image. After obtaining the target detection result, the server 200 may return the target detection result to the terminal 400 through the network 300.

The target detection method provided in the embodiments of this disclosure may be applied to a self-driving scenario, an image search scenario, and a scenario of a recommendation system. In the self-driving scenario, a terminal may acquire a surrounding image in a self-driving process as a target image and transmit the target image to a server. The server performs closed-set target detection on the target image by using a closed-set target detection model to obtain a first target detection result; performs open-set target detection on the target image by using an open-set target detection model to obtain a second target detection result, detection accuracy of the closed-set target detection model being higher than detection accuracy of the open-set target detection model; and finally fuses the first target detection result and the second target detection result to obtain a target detection result of the target image. The server transmits the recognized target detection result to the terminal, and the terminal uses the target detection result as a corresponding self-driving instruction.

In the image search scenario, a user may input a target image for which image search is required on a terminal, and the terminal may transmit the target image to a server. The server performs closed-set target detection on the target image by using a closed-set target detection model to obtain a first target detection result; performs open-set target detection on the target image by using an open-set target detection model to obtain a second target detection result, detection accuracy of the closed-set target detection model being higher than detection accuracy of the open-set target detection model; and finally fuses the first target detection result and the second target detection result to obtain a target detection result of the target image. The server transmits the recognized target detection result to the terminal, and the terminal displays the target detection result to the user.

In the recommendation system, a terminal may obtain, with permission of a user, a commodity interface frequently browsed by the user as a target image, and then transmit the target image to a server. The server performs closed-set target detection on the target image by using a closed-set target detection model to obtain a first target detection result; performs open-set target detection on the target image by using an open-set target detection model to obtain a second target detection result, detection accuracy of the closed-set target detection model being higher than detection accuracy of the open-set target detection model; and finally fuses the first target detection result and the second target detection result to obtain a target detection result of the target image. The server transmits the recognized target detection result to the terminal, the terminal delivers the target detection result into a recommendation model, and the recommendation model outputs a recommendation result.

An electronic device configured to perform the target detection method provided in the embodiments of this disclosure may be one of various types of terminal devices or servers. In some embodiments, the server 200 may be an independent physical server, or may be a server cluster or distributed system formed by a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), and a big data and AI platform.

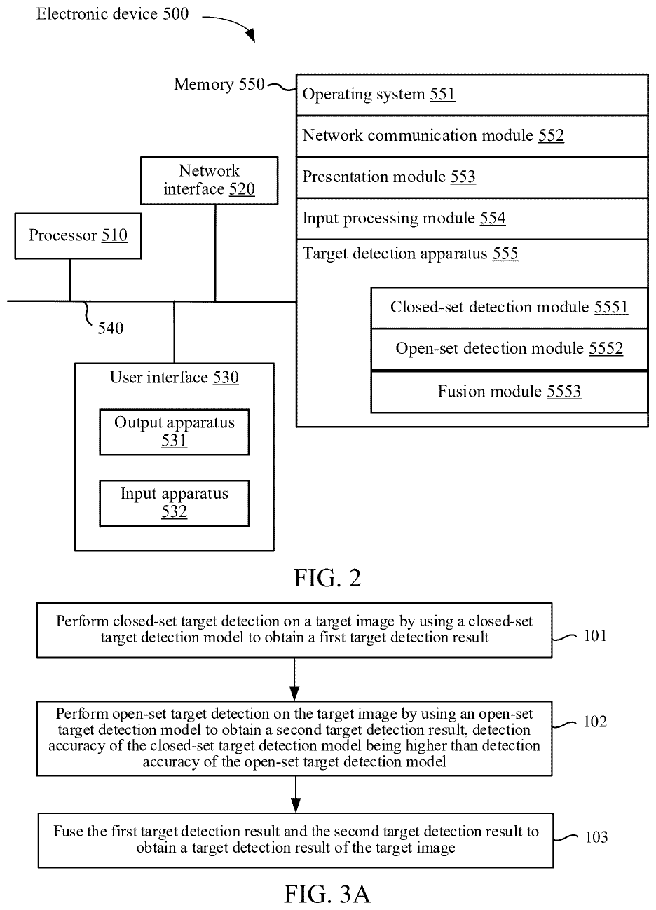

FIG. 2 is a schematic structural diagram of an electronic device 500 according to an embodiment of this disclosure. The electronic device 500 shown in FIG. 2 includes at least one processor 510, a memory 550, at least one network interface 520, and a user interface 530. The components in the electronic device 500 are coupled together by a bus system 540. The bus system 540 is configured to implement connection and communication between the components. In addition to a data bus, the bus system 540 further includes a power bus, a control bus, and a status signal bus. However, for case of clear description, all types of buses in FIG. 2 are marked as the bus system 540.

Processing circuitry, such as the processor 510, may be an integrated circuit chip having a signal processing capability, for example, a general purpose processor, a digital signal processor (DSP), or another programmable logic device (PLD), discrete gate, transistor logical device, or discrete hardware component. The general purpose processor may be a microprocessor, any conventional processor, or the like.

The user interface 530 includes one or more output apparatuses 531 that enable the presentation of media content, including one or more speakers and/or one or more visual displays. The user interface 530 further includes one or more input apparatuses 532, including a user interface part that facilitates user input, for example, a keyboard, a mouse, a microphone, a touchscreen display, a camera, or another input button or control.

The memory 550, such as a non-transitory computer-readable storage medium, may be a removable memory, a non-removable memory, or a combination thereof. An example hardware device includes a solid-state memory, a hard disk drive, an optical disk drive, and the like. In some embodiments, the memory 550 includes one or more storage devices having physical locations far away from the processor 510.

The memory 550 includes a volatile memory or a non-volatile memory, or may include a volatile memory and a non-volatile memory. The non-volatile memory may be a read-only memory (ROM), and the volatile memory may be a random access memory (RAM). The memory 550 described in the embodiments of this disclosure aims to include any suitable type of memories.

In some embodiments, the memory 550 can store data to support various operations. Examples of the data include a program, a module, a data structure, or a subset or superset thereof, and are exemplarily described below.

An operating system 551 includes system programs configured for processing various basic system services and performing hardware-related tasks, for example, a framework layer, a kernel library layer, and a driver layer, and is configured to implement various basic services and process hardware-based tasks.

A network communication module 552 is configured to reach another electronic device through one or more (wired or wireless) network interfaces 520. For example, network interface 520 includes Bluetooth, Wi-Fi, a universal serial bus (USB), and the like.

A presentation module 553 is configured to enable presentation of information (for example, a user interface configured for operating a peripheral and displaying content and information) through the one or more output apparatuses 531 (for example, a display, and a speaker) associated with the user interface 530.

An input processing module 554 is configured to detect one or more user inputs or interactions from the one or more input apparatuses 532 and translate the detected input or interaction.

In some embodiments, an apparatus provided in the embodiments of this disclosure may be implemented in a software manner. FIG. 2 shows a target detection apparatus 555 stored in the memory 550. The apparatus may be software in a form of a program, a plug-in, or the like, and includes the following software modules: a closed-set detection module 5551, an open-set detection module 5552, and a fusion module 5553. These modules are logical modules, and therefore may be combined or split in any manner according to functions to be further implemented. The functions of the modules are described below.

In some other embodiments, the apparatus provided in the embodiments of this disclosure may be implemented in a hardware manner. In an example, the apparatus provided in the embodiments of this disclosure may be a processor in the form of a hardware decoding processor, and is programmed to perform the target detection method provided in the embodiments of this disclosure. For example, the processor in the form of a hardware decoding processor may use one or more application-specific integrated circuits (ASIC), a DSP, a PLD, a complex PLD (CPLD), a field programmable gate array (FPGA), or another electronic element.

The target detection method provided in the embodiments of this disclosure is described below. As described above, the electronic device that implements the target detection method in the embodiments of this disclosure may be a terminal, a server, or a combination thereof. Therefore, an execution body of the operations is not described repeatedly below.

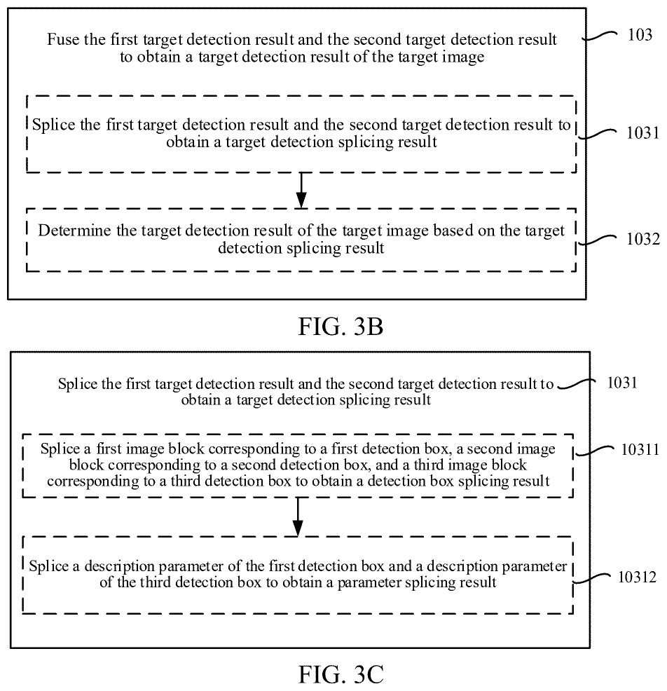

FIG. 3A is a first schematic flowchart of a target detection method according to an embodiment of this disclosure. The operations shown in FIG. 3A are described.

Operation 101: Perform closed-set target detection on a target image by using a closed-set target detection model to obtain a first target detection result.

In an example, before the target detection method provided in the embodiments of this disclosure is implemented, a target image for target detection first needs to be obtained. The obtained target image may be a target image acquired by using an acquisition device of a terminal, or may be a target image uploaded by a user, or may be a target image obtained from a database. An obtaining manner of the target image and a source of the target image may be selected according to an actual case. This is not specifically limited herein.

In an example, after the target image is obtained, closed-set target detection may be performed on the target image by using the closed-set target detection model to obtain the first target detection result.

In an example, closed-set detection is a process of detecting and recognizing a target in a predefined class set. The closed-set detection performs target detection in a range of known classes, i.e., a model can only recognize trained classes but cannot recognize a target that appears in an image but does not belong to the known classes.

In an example, a closed-set detection model is a target detection model configured to recognize a group of predefined classes. The closed-set detection model focuses on only these classes during training, expects to be able to recognize and locate targets of these classes during testing. The closed-set detection model may include an R-CNN, a mask R-CNN, a RetinaNet, and the like.

Operation 102: Perform open-set target detection on the target image by using an open-set target detection model to obtain a second target detection result, detection accuracy of the first target detection result being higher than detection accuracy of the second target detection result.

In an example, open-set detection is a process of detecting a target object by using a machine learning algorithm and a computer vision technology. In this process, the open-set detection mainly recognizes a region or a position of the target object by analyzing an environment around the target object and using an open set theory. Specifically, in an open-set detection technology, a difference between the target object and a surrounding background may be recognized by analyzing pixels or features in an image, to determine a position and a boundary box of a target.

In an example, an open-set detection model can recognize an unknown target appearing in an image, and is not limited to recognizing predefined classes. For example, the open-set detection model may be one of models such as a label prompt target detection large model, a deep learning-based prototypical network, an autoencoder, and a multi-task learning model.

Operation 103: Fuse the first target detection result and the second target detection result to obtain a target detection result of the target image.

In some embodiments, the fusing the first target detection result and the second target detection result to obtain a target detection result of the target image in Operation 103 may be implemented through Operation 1031 and Operation 1032 shown in FIG. 3B.

Operation 1031: Splice the first target detection result and the second target detection result to obtain a target detection splicing result.

In some embodiments, the first target detection result includes a first detection box with a description parameter and a second detection box without a description parameter, and the second target detection result includes a third detection box with a description parameter; and the target detection splicing result includes a detection box splicing result and a parameter splicing result. The splicing the first target detection result and the second target detection result to obtain a target detection splicing result in Operation 1031 may be implemented through Operation 10311 and Operation 10312 shown in FIG. 3C.

Operation 10311: Splice a first image block corresponding to a first detection box, a second image block corresponding to a second detection box, and a third image block corresponding to a third detection box to obtain a detection box splicing result.

In an example, because the closed-set target detection model is obtained by training a limited number of training samples, in a process of detecting a target by the closed-set target detection model, a target object that the closed-set detection model cannot recognize may exist in the target image. Therefore, the first target detection result includes a known detection result that can be accurately detected by the closed-set target detection model and an unknown detection result that cannot be accurately detected by the closed-set target detection model, the known detection result includes the first detection box with a description parameter, and the unknown detection result includes the second detection box without a description parameter.

In an example, a description parameter of a detection box may include at least one of the following: a confidence of the detection box and a class of the detection box. The confidence of the detection box may be configured for measuring accuracy of the detection box located by the target detection model, or may be configured for measuring accuracy of recognizing the target object in the detection box by the target detection model. An actual meaning of the confidence of the detection box may be at least one of measuring the accuracy of the detection box located by the target detection model and measuring accuracy of recognizing the target object in the detection box by the target detection model, or may be a confidence of the detection box obtained by combining measuring the accuracy of the detection box located by the target detection model and measuring accuracy of recognizing the target object in the detection box by the target detection model. The actual meaning of the confidence of the detection box may be selected according to an actual case. This is not specifically limited herein.

The class of the detection box may be an image class of the target object in the detection box, i.e., a label class of the target object, for example, a table, a chair, or a clock, or may be a frame class of the detection box. For example, the detection box is a quadrilateral box, a circular box, a polygonal box, or a box of another shape. An actual meaning of the class of the detection box may be one of the label class of the target object and the frame class of the detection box, or may be a class of the detection box that includes both the label class of the target object and the frame class of the detection box. The actual meaning of the class of the detection box may be selected according to an actual case. This is not specifically limited herein.

In an example, the first image block corresponding to the first detection box includes an image block A and an image block B, the second image block corresponding to the second detection box includes an image block C and an image block D, and the third image block corresponding to the third detection box includes an image block E and an image block F. The detection box splicing result obtained by splicing the first image block, the second image block, and the third image block may be [the image block A, the image block B, the image block C, the image block D, the image block E, and the image block F].

In an example, an overlapping image block may exist between the first image block, the second image block, and the third image block, i.e., the first image block includes an image block A and an image block B, the second image block includes the image block B and an image block C, and the third image block includes the image block C and an image block D. In this case, a choice may be made according to the confidences of the image blocks. For example, a confidence of the image block B in the first image block is 0.9, and a confidence of the image block B in the second image block is 0.7. The image block B included in the detection box splicing result obtained through splicing is the image block B included in the first image block. Similarly, if a confidence of the image block C in the second image block is 0.8 and a confidence of the image block C in the third image block is 0.7, the image block C included in the detection box splicing result obtained through splicing is the image block C included in the second image block.

Operation 10312: Splice a description parameter of the first detection box and a description parameter of the third detection box to obtain a parameter splicing result.

In an example, the description parameter of the first detection box is a description parameter A, and the description parameter of the third detection box is a description parameter C. The parameter splicing result may be [the description parameter A and the description parameter C].

In some embodiments, after the performing closed-set target detection on a target image by using a closed-set target detection model to obtain a first target detection result in Operation 101 is performed, the following technical solution may be further performed: performing similarity matching on the second detection box to obtain a description parameter of the second detection box. After the foregoing technical solution is performed, the splicing a description parameter of the first detection box and a description parameter of the third detection box to obtain a parameter splicing result in Operation 10312 may be implemented through the following technical solution: splicing the description parameter of the first detection box, the description parameter of the second detection box, and the description parameter of the third detection box to obtain the parameter splicing result.

In an example, the description parameter of the first detection box is a description parameter A, the description parameter of the second detection box is a description parameter B, and the description parameter of the third detection box is a description parameter C. The parameter splicing result may be [the description parameter A, the description parameter B, and the description parameter C].

In some embodiments, the description parameter of the second detection box includes an image class of the second detection box and a detection box confidence of the second detection box; and the performing similarity matching on the second detection box to obtain a description parameter of the second detection box may be implemented through the following technical solution: obtaining a class feature of a candidate detection class; performing image feature extraction on the second image block corresponding to the second detection box to obtain an image feature of the second image block corresponding to the second detection box; determining a feature similarity between the image feature and the class feature; and in a case that the feature similarity is greater than a similarity threshold, using the candidate detection class corresponding to the class feature as the image class of the second detection box, and using the feature similarity as the detection box confidence of the second detection box.

In an example, the class feature of the candidate detection class and the image feature of the second image block corresponding to the second detection box may be first obtained, and the class of the second detection box is determined by determining the similarity between the class feature and the image feature.

In an example, the candidate detection class may be a preset class that may exist in the target image. For example, the candidate detection class may include a clock, a table, a chair, a telephone, and the like.

In some embodiments, the obtaining a class feature of a candidate detection class may be implemented through Operation 10312A to Operation 10312D shown in FIG. 3D.

Operation 10312A: Obtain a keyword of the candidate detection class.

In an example, after the candidate detection class is determined, a keyword of each candidate detection class may be determined. The keyword of the candidate detection class is a keyword related to the candidate detection class.

In an example, a candidate detection class A is “cat”, and a keyword of the candidate detection class A may be “short-haired cat”. A candidate detection class B is “table”, and a keyword of the candidate detection class B may be “table”.

Operation 10312B: Generate a text description of the keyword based on the keyword of the candidate detection class.

In an example, to improve accuracy of a class feature corresponding to a subsequent candidate detection class, each candidate class may include a plurality of keywords. A technical solution when each candidate class includes a plurality of keywords is described below.

In some embodiments, the text description of the keyword includes a first text description and a second text description, and the generating a text description of the keyword based on the keyword of the candidate detection class in Operation 10312B may be implemented through the following technical solution: performing synonym expansion on the keyword to obtain a synonymous keyword of the keyword; and performing text generation on the keyword and the synonymous keyword to obtain the first text description including the keyword and the second text description including the synonymous keyword.

In an example, after the keyword of the candidate detection class is determined, synonym expansion may be performed on the keyword to obtain the synonymous keyword of the keyword.

In an example, a keyword A is “short-haired cat”, and a synonymous keyword B of the keyword A may be “long-haired cat”. A keyword C is “chair”, and a synonymous keyword C of the keyword C may be “recliner”.

In an example, synonym expansion may be performed based on a large language model. To be specific, a keyword is used an input of the large language model, a generated synonym is used as a prompt of the large language model, and the large language model outputs a synonymous keyword of the keyword.

In an example, the large language model is a machine learning model configured to generate a natural language text, and may process languages with extensive meanings and complex structures in fields such as dialog systems, automatic writing, and smart customer service. The large language model usually uses deep learning technologies, especially a recurrent neural network (RNN), a long short-term memory network (LSTM), a gated recurrent unit (GRU), or another recursive neural network structure and a transformer model. The large language model may process a large amount of text data, and generate a natural and smooth text by learning the syntactic, semantic, and context information of a language. The large language model usually requires a large amount of annotated data for training, and requires high-performance computer or cloud computing resources to process large-scale data.

In an example, after the keyword and the synonymous keyword are obtained, the first text description may be generated based on the obtained keyword, and the second text description may be generated based on the synonymous keyword.

In an example, a keyword A is “short-haired cat”, and the first text description may be that “There is a short-haired cat here”. A synonymous keyword of the keyword A is “long-haired cat”, and the second text description may be that “There is a long-haired cat here”.

The first text description and the second text description in the foregoing example have the same sentence structure, and only have different keywords. The first text description and the second text description may have the same sentence structure or may have different sentence structures.

In an example, a keyword A is “short-haired cat”, and the first text description may be that “There is a short-haired cat at the door”. A synonymous keyword of the keyword A is “long-haired cat”, and the second text description may be that “The long-haired cat is so pretty”.

In an example, after the keyword and the synonymous keyword are obtained, the keyword and the synonymous keyword may be inputted into the large language model, a generated text description is used as a prompt, and the large language model generates the first text description corresponding to the keyword and the second text description corresponding to the synonymous keyword.

In the foregoing manner, a quantity of keywords included in each class can be increased, thereby improving accuracy of subsequent class features.

Operation 10312C: Perform text feature extraction on the text description of the keyword to obtain a text feature of the text description of the keyword.

In some embodiments, the performing text feature extraction on the text description of the keyword to obtain a text feature of the text description of the keyword in Operation 10312C may be implemented through the following technical solution: tokenizing the text description to obtain a lexical unit included in the text description; performing feature embedding on the lexical unit to obtain a unit embedding feature of the lexical unit; and splicing unit embedding features of a plurality of lexical units to obtain the text feature of the keyword.

In an example, text description information may be tokenized first to obtain a lexical unit included in a text description. This process usually includes segmenting words, punctuation, digits, and the like in a text and removing some noise or redundant information.

In an example, text description information A is “There is a cat sitting at the door”. The text description information A is segmented, and obtained lexical units of the text description information A may be “there is”, “a”, “cat”, “sitting”, “at”, and “the door”.

In an example, after a lexical unit of the text description information is obtained, feature embedding may be performed on the lexical unit to obtain a unit embedding feature of the lexical unit. In other words, the lexical unit is mapped to a vector space.

In an example, pretrained word vector models (for example, Word2Vec) may be used to perform feature embedding on the lexical unit. These models map each lexical unit to a vector with a fixed length, so that a vector of each lexical unit represents that semantic and context information of the lexical unit can be captured.

In an example, the word vector model (Word2Vec) is a word embedding model. Word2Vec can learn a distributed representation of words through training, i.e., map each word to a continuous vector space. Word2Vec can capture a semantic relationship between words, to provide an effective feature representation method for natural language processing tasks.

In an example, lexical units of text description information A may be “there is”, “a”, “cat”, “sitting”, “at”, and “the door”. Unit embedding features corresponding to the text description information A that can be obtained through feature embedding are respectively token1 (a unit embedding feature corresponding to “there is”), token2 (a unit embedding feature corresponding to “a”), token3 (a unit embedding feature corresponding to “cat”), token4 (a unit embedding feature corresponding to “sitting”), token5 (a unit embedding feature corresponding to “at”), and token6 (a unit embedding feature corresponding to “the door”).

In an example, after the unit embedding features are obtained, the unit embedding features may be spliced to obtain the text feature of the keyword.

In an example, unit embedding features corresponding to text description information A are respectively token1 (a unit embedding feature corresponding to “there is”), token2 (a unit embedding feature corresponding to “a”), token3 (a unit embedding feature corresponding to “cat”), token4 (a unit embedding feature corresponding to “sitting”), token5 (a unit embedding feature corresponding to “at”), and token6 (a unit embedding feature corresponding to “the door”). The unit embedding features token1, token2, token3, token4, token5, and token6 of the text description information A may be spliced, and a feature obtained through splicing is used as the text feature of the keyword.

In the foregoing manner, accuracy of an extracted text feature can be improved, thereby improving accuracy of subsequently determining class features.

Operation 10312D: Determine the class feature of the candidate detection class based on the text feature of the text description of the keyword.

In some embodiments, the determining the class feature of the candidate detection class based on the text feature of the text description of the keyword in Operation 10312D may be implemented through the following technical solution: in a case that the keyword has a plurality of text descriptions, fusing text features of the plurality of text descriptions to obtain a keyword feature of the keyword; in a case that the keyword has one text description, determining a text feature of the text description as a keyword feature of the keyword; in a case that the keyword has a synonymous keyword, fusing a keyword feature of the keyword and a keyword feature of the synonymous keyword to obtain the class feature of the candidate detection class; and in a case that the keyword does not have a synonymous keyword, determining a keyword feature of the keyword as the class feature of the candidate detection class.

In an example, when one keyword has only one text description, a text feature of the text description may be determined as a keyword feature.

In an example, when one keyword has a plurality of text descriptions, text features of the plurality of text descriptions of the keyword need to be fused.

In an example, a keyword A is “short-haired cat”, a text description B corresponding to the keyword A is “There is a short-haired cat here”, and a text description C corresponding to the keyword A is “The short-haired cat is so pretty”. In this case, a text feature D corresponding to the text description B and a text feature E corresponding to the text description C may be fused to obtain a keyword feature of the keyword A.

In an example, a manner of fusing text features may be determining a mean text feature of text features corresponding to a plurality of text descriptions, and using the obtained mean text feature as a keyword feature of keywords corresponding to the text descriptions.

In an example, if the keyword has a synonymous keyword, a keyword feature of the keyword and a keyword feature of the synonymous keyword may be fused to obtain the class feature of the candidate detection class.

In an example, after a keyword feature corresponding to a keyword is determined, a keyword feature of a synonymous keyword corresponding to the keyword may be determined based on the same method. Subsequently, a keyword feature corresponding to a keyword and a keyword feature corresponding to a synonymous keyword that belong to one same candidate detection class may be fused to obtain the class feature of the candidate detection class.

In an example, after the keyword feature corresponding to the keyword and the keyword feature of the synonymous keyword are obtained, the keyword feature of the keyword and the keyword feature of the synonymous keyword may be summed, a summation result is averaged subsequently to obtain a mean keyword feature, and the mean keyword feature may be used as the class feature of the candidate detection class.

In an example, if the keyword does not have a synonymous keyword, the keyword feature of the keyword is determined as the class feature of the candidate detection class.

In an example, in the foregoing manner, more text features and keyword features can be fused, to improve accuracy of obtained class features, thereby improving accuracy of subsequent target detection.

In an example, a process of performing image feature extraction on the second image block corresponding to the second detection box may be implemented through a CLIP model.

CLIP uses a large number of images and texts for pretraining to learn a model of associating image content and natural language descriptions. Specifically, the CLIP model uses a large number of images and corresponding descriptive texts collected from the internet. These texts may be titles, labels or other description information of images. The CLIP model includes two encoders, namely, an image encoder and a text encoder. The image encoder usually uses a convolutional neural network to extract a feature of an image, and the text encoder uses a transformer architecture to extract a feature of a text. The image encoder processes an image to generate a feature representation, and the text encoder processes a text to also generate a feature representation. The two feature representations are respectively internal representations of the image and the text in the model. CLIP trains the model by comparing the feature representations of the image and the text. CLIP generates one positive sample for each pair of image and text, i.e., an image and a text corresponding to the image, and generates a plurality of negative samples for each pair of image and text, i.e., an image and another unmatched text. In a pretraining phase, the CLIP model is trained based on a large amount of image-text pair data, and learned features may be configured for subsequent tasks such as image classification and target detection. In a specific downstream task, the CLIP model may perform fine tuning, i.e., use a small amount of data to adjust parameters of the model, to better adapt to a specific task requirement.

In an example, in addition to using the CLIP model to perform image feature extraction, neural networks such as a convolutional neural network, an RNN, a generator in a generative adversarial network, an autoencoder, and an image convolutional neural network may be used to perform image feature extraction. A neural network that performs image feature extraction on the second image block to obtain the image feature may be selected according to an actual case. This is not specifically limited herein.

In an example, after the image feature and the class feature are determined, the feature similarity between the image feature and the class feature may be determined. Specifically, a cosine similarity between the image feature and the class feature may be calculated through the foregoing CLIP model, to obtain the feature similarity between the image feature and the class feature.

Specifically, the cosine similarity between the image feature and the class feature may be calculated through the following formula:

$$COS ( a , b ) = \frac{a * b}{‖ a ‖ * ‖ b ‖} . \qquad ( 1 )$$

In Formula (1), a is the image feature, b is the class feature, ∥a∥ is a modulus of the image feature, ∥b∥ is a modulus of the class feature, and COS(a, b) is the cosine similarity between the image feature and the class feature.

As can be learned from Formula (1), when the cosine similarity is larger, the image feature and the class feature are less similar. Therefore, the opposite of the cosine similarity may be used as the feature similarity between the image feature and the class feature. The foregoing is only a processing manner of the cosine similarity. The reciprocal of the cosine similarity may be used as the feature similarity between the image feature and the class feature. A process of processing the cosine similarity may be selected according to an actual case. This is not specifically limited herein.

In an example, the foregoing is only a manner of determining the feature similarity between the image feature and the class feature through a cosine similarity. The feature similarity between the image feature and the class feature may be determined by using a Euclidean distance between the image feature and the class feature or in another manner. A manner of determining the feature similarity between the image feature and the class feature may be selected according to an actual case. This is not specifically limited herein.

In an example, after the feature similarity is obtained, in a case that the feature similarity is greater than a similarity threshold, the candidate detection class corresponding to the class feature may be used as the class of the second detection box.

In an example, the similarity threshold is 0.8, a feature similarity between an image feature B corresponding to a second detection box A and a class feature C with a candidate detection class being “chair” is 0.85, and “chair” may be used as the class of the second detection box.

In an example, the feature similarity reflects a similarity the target object in the second detection box and the candidate detection class. To be specific, a higher feature similarity indicates that the target object in the second detection box belongs to the candidate detection class more likely. Therefore, after the class of the second detection box is determined, the feature similarity between the image feature corresponding to the second detection box and the class feature of the class may be used as the detection box confidence of the second detection box.

Operation 1032: Determine the target detection result of the target image based on the target detection splicing result.

In some embodiments, the description parameter includes a detection box confidence, and the determining the target detection result of the target image based on the target detection splicing result in Operation 1032 may be implemented through the following technical solution: performing target image block-based image segmentation on the target image to obtain at least one mask that belongs to a target image block and a mask confidence of each mask, where the target image block is any image block from the detection box splicing result; generating a bounding box corresponding to a first mask in the target image as a target detection box, where the first mask is any one of the at least one mask; determining a target confidence of the target detection box based on the detection box confidence included in the parameter splicing result and a mask confidence of the first mask; and generating the target detection result based on the target detection box and the target confidence.

In an example, the target image block and the target image may be inputted into a segment anything model (SAM), and the SAM model outputs the first mask and the confidence of the first mask.

In an example, the SAM model intends to implement an image segmentation task. The design concept of the SAM model is to obtain an extensive generalization capability and make it possible to generate a precise segmentation mask for any object in an image, even if an object and an image type that have not been directly encountered in a training process. This capability is referred to as zero sample migration in the field of deep learning, and is an important feature of the SAM model.

The SAM model is formed by an encoder and a decoder. The basic principle is processing an inputted image through the encoder to capture global features and context information in the image. The decoder part is responsible for generating precise segmentation masks for objects in the image according to information provided by the encoder.

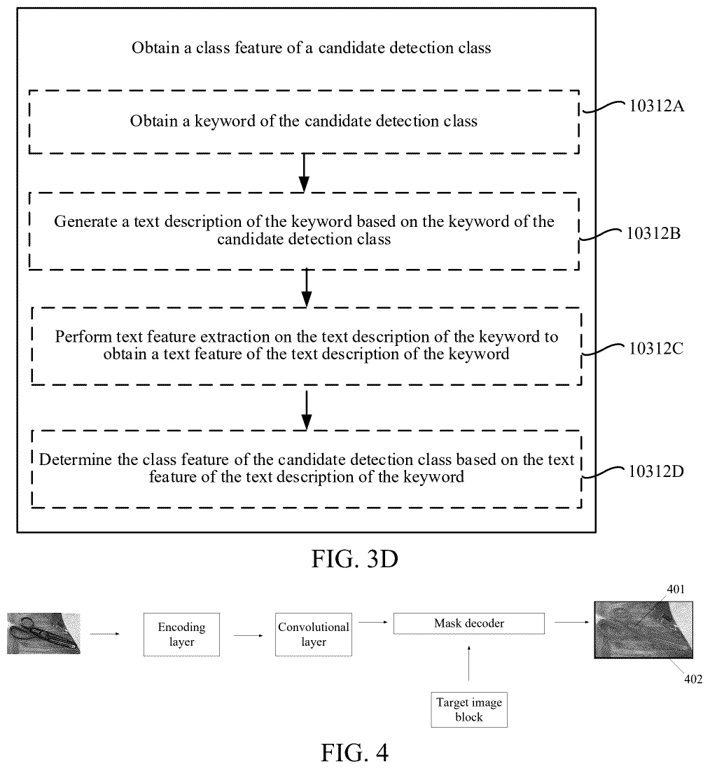

In an example, a process of determining the target detection result of the target image is described below with reference to FIG. 4. FIG. 4 is a working principle diagram of a segmentation model according to an embodiment of this disclosure.

First, a target image is inputted into an encoding layer, subsequently an image feature of the target image is obtained through convolution processing, and then a target image block is inputted as a prompt into a mask decoder to obtain an outputted first mask (as shown by 401 in FIG. 4) of the target image block and a mask confidence corresponding to each mask.

In an example, after the first mask of the target image block is obtained, a bounding box of the first mask may be generated, and as shown by 402 in FIG. 4, the bounding box is used as the target detection box.

In an example, the target confidence of the target detection box is determined based on the detection box confidence included in the parameter splicing result and the mask confidence. A process of determining the target confidence is described below in detail.

In some embodiments, the determining a target confidence of the target detection box based on the detection box confidence included in the parameter splicing result and a mask confidence of the first mask may be implemented through the following technical solution: standardizing the detection box confidence and the mask confidence of the first mask to obtain a standardized detection box confidence and a standardized mask confidence respectively; and multiplying the standardized detection box confidence and the standardized mask confidence that have a correspondence to obtain the target confidence, where the correspondence represents that the first mask corresponding to the standardized mask confidence is inside a detection box corresponding to the standardized detection box confidence.

In an example, after the mask confidence and the detection box confidence are obtained, the mask confidence and the detection box confidence may be standardized by using the following Formula (2).

$${x}^{′} = \frac{x - min ( x )}{max ( x ) - min ( x )} . \qquad ( 2 )$$

In Formula (2), x′ is a result of standardization, x is a standardized sequence, min (x) is a minimum value in the standardized sequence, and max (x) is a maximum value in the standardized sequence.

In an example, the detection box confidence may be substituted as a standardized sequence into Formula (2) to obtain x′, i.e., the standardized detection box confidence. Similarly, the mask confidence may be substituted into Formula (2) to obtain x′, i.e., the standardized mask confidence. The detection box confidence and the mask confidence may be fused into a standardized sequence to be substituted into Formula (2) to obtain the standardized detection box confidence and the standardized mask confidence after the standardization.

In an example, after the standardized detection box confidence and the standardized mask confidence are obtained, the standardized detection box confidence and the standardized mask confidence that have a correspondence may be multiplied to obtain the target confidence.

In an example, a detection box A includes an image block A, and a mask B is obtained based on the image block A. Therefore, the detection box A and the mask B have a correspondence. If a standardized detection box confidence corresponding to the detection box A is 0.7 and a standardized mask confidence corresponding to the mask B is 0.8, a target confidence is 0.7*0.8=0.56.

In the foregoing manner, accuracy of the detection box confidence can be improved, thereby improving accuracy of target detection.

In an example, after the target confidence is obtained, the target detection result may be generated based on the target confidence and the target detection box.

In an example, in a process of generating the target detection result, a class of the detection box may be used as a part of the target detection result.

An example application of this disclosure is described below.

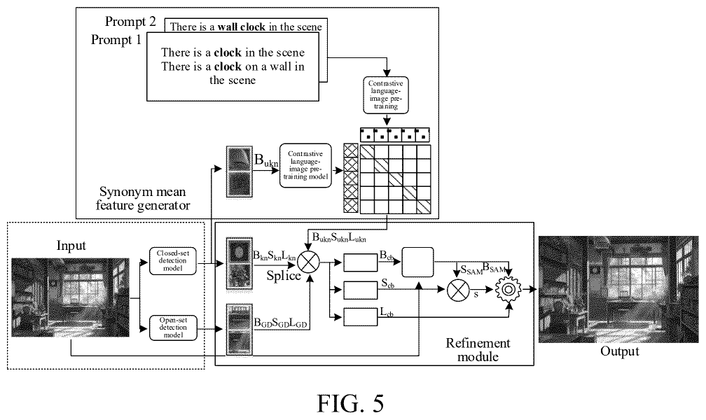

An overall procedure of the embodiments of this disclosure in an scenario is described first with reference to FIG. 5.

A target image is inputted first, and then target detection is performed on the target image by using two pretrained models. The two pretrained models are a closed-set detection model (Mask-RCNN) and an open-set detection model (GroundingDINO). The second target detection result may be obtained by detecting the target image by using the open-set detection model. The second target detection result includes a detection box B_{GD} (bounding box), a score S_{GD} (score) of the detection box, and a class L_{GD} (label, i.e., a class label) of the detection box. An output of the closed-set detection model includes two parts. One is the first target detection result. The first target detection result includes a detection box B_{KN} (bounding box), a score S_{KN} (score) of the detection box, and a class L_{KN} (label, i.e., a class label) of the detection box. The other is an unknown detection result. The unknown detection result includes a detection box B_{UKN}, a score S_{UKN} of an unknown detection box, and a class L_{UKN} of the unknown detection box. Subsequently, a first detection result, a second detection result, and the unknown detection result are respectively inputted into a synonym mean feature generator (synonym embedding generator, SEG) and a refinement module for subsequent calculation, to finally obtain the target detection result shown in FIG. 5.

A working principle of the SEG is described below in detail.

First, SEG may be defined as a template set. The template set may include a plurality of templates of different classes (target classes). A prompt 1 and a prompt 2 shown in FIG. 5 are templates that belong to the same class.

Subsequently, the SEG may define a plurality of keywords in each class that are synonyms of each other. In a definition process, a keyword is first determined, and subsequently synonyms of the keyword are determined as a plurality of synonymous keywords, for example, “clock” and “wall clock” in FIG. 5, of the class.

Next, in each template, a group of text prompts are generated according to respective keywords. For example, text descriptions such as “There is a clock in the scene” and “There is a wall clock on a wall in the scene” are generated according to the keyword “clock”.

Further next, in each template, each text description is tokenized and encoded through CLIP to obtain a text feature (embedding) corresponding to each text description.

Next, text embedding in each template is normalized, and a mean feature vector is calculated as a text feature of the template.

Next, text features of different templates that belong to a synonym are summed, and a mean feature is calculated to obtain a final feature representation TI of the class.

Finally, the cosine of the CLIP model is used as an example of a calculation manner to obtain a class label of the image.

An input of the SEG is an unknown object detected by the Mask-RCNN, and is denoted by small image blocks. Outputs are score values of a class and a probability of an image block obtained through calculation using CLIP, i.e., the second detection box included in the unknown detection result and the description parameter of the second detection box.

The SEG has a function of performing synonymous expansion on a class to obtain richer semantic information, and may be used as a normal form of generating a text description.

A working principle of Refinement is described below.

First, obtained B_{GD}, S_{GD}, L_{GD}, B_{KN}, S_{KN}, L_{KN}, B_{UKN}, S_{UKN}, and L_{UKN} are spliced to obtain and input complete detection results, i.e., B_{GD}, B_{KN}, and B_{UKN} are spliced to obtain B_{CB}, S_{GD}, S_{KN}, and S_{UKN} are spliced to obtain S_{CB}, and L_{GD}, L_{KN}, and L_{UKN} are spliced to obtain L_{CB}.

Subsequently, detection boxes in the detection results are refined by using a structural analysis model (SAM). The target image and the detection box B_{CB} (the detection box B_{CB} is used as a prompt) are inputted into the SAM model, and two values are outputted. One output result is a mask corresponding to a target object, and then a bounding box of the mask is used as a final detection box B_{SAM}. The other output result is a score S_{SAM} corresponding to each mask.

Next, the two scores (S_{CB} and S_{SAM}) are fused by using a score refinement module (SRM) to output a final score S. A manner of fusing S_{CB} and S_{SAM} may be: standardizing S_{CB} and S_{SAM} by using a minimax algorithm, and then elements at one position are multiplied to obtain a refined score, i.e., a confidence score of each detection box.

Finally, B_{SAM}, S, and L_{CB} are used as the target detection result of the target image.

The refinement module can effectively combine detection results of the closed-set detection model and the open-set detection model, and the refinement of the detection box and the score of the detection box is implemented by using advantages of the two inspection models and a preset method.

The target detection method provided in the embodiments of this disclosure can expand a detection range of an existing detector to an open set by using an innovative collaboration mechanism without training. The entire architecture of the target detection method provided in the embodiments of this disclosure uses a modular design and can seamlessly integrate another detector. The collaboration mechanism provided in the target detection method provided in the embodiments of this disclosure can be applied to target detection, and can also be applied to an image segmentation task.

In embodiments of this disclosure, related data such as user information are involved. When the embodiments of this disclosure are used in specific products or technologies, user permissions or agreements need to be obtained, and the collection, use, and processing of relevant data need to comply with the relevant laws, regulations, and standards of the relevant countries and regions.

An example structure of a target detection apparatus 555 implemented as software modules provided in the embodiments of this disclosure continues to be described below. In some embodiments, as shown in FIG. 2, the software modules in the target detection apparatus 555 stored in a memory 550 may include:
a closed-set detection module 5551, configured to perform closed-set target detection on a target image by using a closed-set target detection model to obtain a first target detection result;
an open-set detection module 5552, configured to perform open-set target detection on the target image by using an open-set target detection model to obtain a second target detection result, detection accuracy of the first target detection result being higher than detection accuracy of the second target detection result; and
a fusion module 5553, configured to fuse the first target detection result and the second target detection result to obtain a target detection result of the target image.

In some embodiments, the fusion module 5553 is further configured to: splice the first target detection result and the second target detection result to obtain a target detection splicing result; and determine the target detection result of the target image based on the target detection splicing result.

In some embodiments, the fusion module 5553 is further configured to: splice a first image block corresponding to a first detection box, a second image block corresponding to a second detection box, and a third image block corresponding to a third detection box to obtain a detection box splicing result; and splice a description parameter of the first detection box and a description parameter of the third detection box to obtain a parameter splicing result.

In some embodiments, the fusion module 5553 is further configured to: perform similarity matching on the second detection box to obtain a description parameter of the second detection box; and splice the description parameter of the first detection box, the description parameter of the second detection box, and the description parameter of the third detection box to obtain the parameter splicing result.

In some embodiments, the fusion module 5553 is further configured to: obtain a class feature of a candidate detection class; perform image feature extraction on the second image block corresponding to the second detection box to obtain an image feature of the second image block corresponding to the second detection box; determine a feature similarity between the image feature and the class feature; and in a case that the feature similarity is greater than a similarity threshold, use the candidate detection class corresponding to the class feature as an image class of the second detection box, and use a feature similarity as the detection box confidence of the second detection box.

In some embodiments, the fusion module 5553 is further configured to: obtain a keyword of the candidate detection class; generate a text description of the keyword based on the keyword of the candidate detection class; perform text feature extraction on the text description of the keyword to obtain a text feature of the text description of the keyword; and determine the class feature of the candidate detection class based on the text feature of the text description of the keyword.

In some embodiments, the fusion module 5553 is further configured to: perform synonym expansion on the keyword to obtain a synonymous keyword of the keyword; and perform text generation on the keyword and the synonymous keyword to obtain a first text description including the keyword and a second text description including the synonymous keyword.

In some embodiments, the fusion module 5553 is further configured to: tokenize the text description to obtain a lexical unit included in the text description; and perform feature embedding on the lexical unit to obtain a unit embedding feature of the lexical unit; and splice unit embedding features of a plurality of lexical units to obtain the text feature of the keyword.

In some embodiments, the fusion module 5553 is further configured to: in a case that the keyword has a plurality of text descriptions, fuse text features of the plurality of text descriptions to obtain a keyword feature of the keyword; in a case that the keyword has one text description, determine a text feature of the text description as a keyword feature of the keyword; in a case that the keyword has a synonymous keyword, fuse a keyword feature of the keyword and a keyword feature of the synonymous keyword to obtain the class feature of the candidate detection class; and in a case that the keyword does not have a synonymous keyword, determine a keyword feature of the keyword as the class feature of the candidate detection class.

In some embodiments, the fusion module 5553 is further configured to: perform target image block-based image segmentation on the target image to obtain at least one mask that belongs to a target image block and a mask confidence of each mask, where the target image block is any image block from the detection box splicing result; generate a bounding box corresponding to a first mask in the target image as a target detection box, where the first mask is any one of the at least one mask; determine a target confidence of the target detection box based on the detection box confidence included in the parameter splicing result and a mask confidence of the first mask; and generate the target detection result based on the target detection box and the target confidence.

In some embodiments, the fusion module 5553 is further configured to: standardize the detection box confidence and the mask confidence of the first mask to obtain a standardized detection box confidence and a standardized mask confidence respectively; and multiply the standardized detection box confidence and the standardized mask confidence that have a correspondence to obtain the target confidence, where the correspondence represents that the first mask corresponding to the standardized mask confidence is inside a detection box corresponding to the standardized detection box confidence.

Embodiments of this disclosure provide a computer program product, the computer program product including a computer program or computer-executable instructions, the computer program or computer-executable instructions being stored in a computer-readable storage medium. A processor of an electronic device reads the computer-executable instructions from the computer-readable storage medium, and the processor executes the computer-executable instructions, to cause the electronic device to perform the foregoing target detection method provided in the embodiments of this disclosure.

Embodiments of this disclosure provide a computer-readable storage medium, storing computer-executable instructions or a computer program. The computer-executable instructions or computer program, when executed by a processor, causes the processor to perform the target detection method provided in the embodiments of this disclosure, for example, the target detection method shown in FIG. 3A.

In some embodiments, the computer-readable storage medium may be a RAM, a ROM, a flash memory, a magnetic surface memory, an optical disc, a compact disc read-only memory (CD-ROM), or another memory, or may be various devices including any one or any combination of the foregoing memories.

In some embodiments, the computer-executable instructions may be written in any form of programming language (including a compiled or interpreted language, or a declarative or procedural language) in the form of a program, software, a software module, a script, or code, and may be deployed in any form, including being deployed as an independent program or being deployed as a module, a component, a subroutine, or another unit suitable for use in a computing environment.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

In an example, the computer-executable instructions may but do not necessarily correspond to a file in a file system, and may be stored as a part of a file that saves other programs or data, for example, stored in one or more scripts in a Hypertext Markup Language (HTML) document, stored in a single file dedicated to a discussed program, or stored in a plurality of collaborative files (for example, files that store one or more modules, subprograms, or code parts).

In an example, the computer-executable instructions may be deployed to be executed on one electronic device, or executed on a plurality of electronic devices located at one place, or executed on a plurality of electronic devices that are distributed at a plurality of places and are interconnected by a communication network.

In summary, the embodiments of this disclosure may achieve the following beneficial effects:

Closed-set target detection is performed on a target image by using a closed-set target detection model to obtain a first target detection result. Subsequently, open-set target detection is performed on the target image by using an open-set target detection model to obtain a second target detection result, detection accuracy of the first target detection result being higher than detection accuracy of the second target detection result. A class of the target image can be accurately recognized by using a closed-set detection model, thereby improving accuracy of a finally obtained target detection result. In addition, classes of all target objects in the target image can be recognized by using an open-set detection model, thereby ensuring that the finally obtained target detection result can include all the target objects in the target image as much as possible. The first target detection result and the second target detection result are fused to obtain a target detection result of the target image. The first target detection result with higher accuracy and the second target detection result that include as many target objects in the target image as possible are fused, so that while the obtained target detection result implements open-set detection, accuracy of target detection is improved.

The foregoing descriptions are merely examples of embodiments of this disclosure and are not intended to limit the scope of this disclosure. Any modification, equivalent replacement, or improvement made without departing from the spirit and range of this disclosure shall fall within the scope of this disclosure.

What is claimed is:

1. A target detection method, the method comprising:
performing, by processing circuitry, a closed-set detection on an image via a closed-set detection model to obtain a first detection result;
performing, by the processing circuitry, an open-set detection on the image via an open-set detection model to obtain a second detection result, accuracy of the first detection result being higher than accuracy of the second detection result; and
merging, by the processing circuitry, the first detection result and the second detection result to obtain a target detection result of the image.

2. The method according to claim 1, wherein the merging the first detection result and the second detection result further comprises:
splicing the first detection result and the second detection result to obtain a target detection splicing result; and
determining the target detection result of the image based on the target detection splicing result.

3. The method according to claim 2, wherein
the first detection result includes a first detection box with a description parameter and a second detection box without a description parameter;
the second detection result includes a third detection box with a description parameter;
the target detection splicing result includes a detection box splicing result and a parameter splicing result; and
the splicing the first detection result and the second detection result further comprises:
splicing a first image block corresponding to the first detection box, a second image block corresponding to the second detection box, and a third image block corresponding to the third detection box to obtain the detection box splicing result, and
splicing the description parameter of the first detection box and the description parameter of the third detection box to obtain the parameter splicing result.

4. The method according to claim 3, wherein
the method further comprises:
performing similarity matching on the second detection box to generate a description parameter of the second detection box; and
the splicing the description parameter of the first detection box and the description parameter of the third detection box includes splicing the description parameter of the first detection box, the description parameter of the second detection box, and the description parameter of the third detection box to obtain the parameter splicing result.

5. The method according to claim 4, wherein
the description parameter of the second detection box includes an image class of the second detection box and a detection box confidence of the second detection box; and
the performing the similarity matching on the second detection box further comprises:
obtaining a class feature of a candidate detection class;
performing image feature extraction on the second image block corresponding to the second detection box to obtain an image feature of the second image block corresponding to the second detection box;
determining a feature similarity between the image feature and the class feature; and
when the feature similarity is greater than a threshold, setting the candidate detection class corresponding to the class feature as the image class of the second detection box, and setting the feature similarity as the detection box confidence of the second detection box.

6. The method according to claim 5, wherein the obtaining the class feature of the candidate detection class further comprises:
obtaining a keyword of the candidate detection class;
generating a text description of the keyword based on the keyword of the candidate detection class;
performing text feature extraction on the text description of the keyword to obtain a text feature of the text description of the keyword; and
determining the class feature of the candidate detection class based on the text feature of the text description of the keyword.

7. The method according to claim 6, wherein the generating the text description of the keyword further comprises:
performing synonym expansion on the keyword to obtain a synonymous keyword of the keyword; and
performing text generation on the keyword and the synonymous keyword to obtain a first text description including the keyword and a second text description including the synonymous keyword.

8. The method according to claim 6, wherein the performing the text feature extraction further comprises:
tokenizing the text description to obtain a lexical unit;
performing feature embedding on the lexical unit to obtain a unit embedding feature of the lexical unit; and
splicing unit embedding features of a plurality of lexical units to obtain the text feature of the keyword.

9. The method according to claim 6, wherein the determining the class feature of the candidate detection class further comprises:
when the keyword has a plurality of text descriptions, merging text features of the plurality of text descriptions to obtain a keyword feature of the keyword;
when the keyword has one text description, determining a text feature of the text description as a keyword feature of the keyword;
when the keyword has a synonymous keyword, merging a keyword feature of the keyword and a keyword feature of the synonymous keyword to obtain the class feature of the candidate detection class; and
when the keyword does not have a synonymous keyword, determining a keyword feature of the keyword as the class feature of the candidate detection class.

10. The method according to claim 3, wherein the method further comprises:
performing block-based image segmentation on the image to obtain at least one mask that belongs to an image block and a mask confidence of the at least one mask, the image block being one of a plurality of image blocks from the detection box splicing result;
generating a bounding box corresponding to a first mask in the image as a target detection box, the first mask being one of the at least one mask;
determining a target confidence of the target detection box based on the detection box confidence and a mask confidence of the first mask; and
generating the target detection result based on the target detection box and the target confidence.

11. The method according to claim 10, wherein the determining the target confidence of the target detection box further comprises:
standardizing the detection box confidence and the mask confidence of the first mask to obtain a standardized detection box confidence and a standardized mask confidence respectively; and
multiplying the standardized detection box confidence and the standardized mask confidence that have a correspondence to obtain the target confidence, the correspondence representing that the first mask corresponding to the standardized mask confidence is inside a detection box corresponding to the standardized detection box confidence.

12. A target detection apparatus, the apparatus comprising:
processing circuitry configured to:
perform a closed-set detection on an image via a closed-set detection model to obtain a first detection result;
perform an open-set detection on the image via an open-set detection model to obtain a second detection result, accuracy of the first detection result being higher than accuracy of the second detection result; and
merge the first detection result and the second detection result to obtain a target detection result of the image.

13. The apparatus according to claim 12, wherein the processing circuitry is further configured to:
splice the first detection result and the second detection result to obtain a target detection splicing result; and
determine the target detection result of the image based on the target detection splicing result.

14. The apparatus according to claim 13, wherein
the first detection result includes a first detection box with a description parameter and a second detection box without a description parameter;
the second detection result includes a third detection box with a description parameter;
the target detection splicing result includes a detection box splicing result and a parameter splicing result; and
the processing circuitry is further configured to:
splice a first image block corresponding to the first detection box, a second image block corresponding to the second detection box, and a third image block corresponding to the third detection box to obtain the detection box splicing result, and
splice the description parameter of the first detection box and the description parameter of the third detection box to obtain the parameter splicing result.

15. The apparatus according to claim 14, wherein the processing circuitry is further configured to:
perform similarity matching on the second detection box to generate a description parameter of the second detection box; and
splice the description parameter of the first detection box, the description parameter of the second detection box, and the description parameter of the third detection box to obtain the parameter splicing result.

16. The apparatus according to claim 15, wherein
the description parameter of the second detection box includes an image class of the second detection box and a detection box confidence of the second detection box; and
the processing circuitry is further configured to:
obtain a class feature of a candidate detection class;
perform image feature extraction on the second image block corresponding to the second detection box to obtain an image feature of the second image block corresponding to the second detection box;
determine a feature similarity between the image feature and the class feature; and
when the feature similarity is greater than a threshold, set the candidate detection class corresponding to the class feature as the image class of the second detection box, and set the feature similarity as the detection box confidence of the second detection box.

17. A non-transitory computer-readable storage medium, storing instructions which when executed by a processor cause the processor to perform:
a closed-set detection on an image via a closed-set detection model to obtain a first detection result;
an open-set detection on the image via an open-set detection model to obtain a second detection result, accuracy of the first detection result being higher than accuracy of the second detection result; and
merging the first detection result and the second detection result to obtain a target detection result of the image.

18. The non-transitory computer-readable storage medium according to claim 17, wherein the instructions when executed by the processor further cause the processor to perform:
splicing the first detection result and the second detection result to obtain a target detection splicing result; and
determining the target detection result of the image based on the target detection splicing result.

19. The non-transitory computer-readable storage medium according to claim 18, wherein
the first detection result includes a first detection box with a description parameter and a second detection box without a description parameter;
the second detection result includes a third detection box with a description parameter;
the target detection splicing result includes a detection box splicing result and a parameter splicing result; and
the instructions when executed by the processor further cause the processor to perform:
splicing a first image block corresponding to the first detection box, a second image block corresponding to the second detection box, and a third image block corresponding to the third detection box to obtain the detection box splicing result, and
splicing the description parameter of the first detection box and the description parameter of the third detection box to obtain the parameter splicing result.

20. The non-transitory computer-readable storage medium according to claim 19, wherein the instructions when executed by the processor further cause the processor to perform:
similarity matching on the second detection box to generate a description parameter of the second detection box; and
splicing the description parameter of the first detection box, the description parameter of the second detection box, and the description parameter of the third detection box to obtain the parameter splicing result.
